(19) United States
(12) Patent Application Publication
(10) Pub. No.: US 2009/0066676 A1
(43) Pub. Date: Mar. 12, 2009

(54) DATA LINE DRIVING CIRCUIT, ELECTRO-OPTICAL APPARATUS, AND ELECTRONIC APPARATUS

(75) Inventor: Hiroaki JO, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/181,680

(22) Filed: Jul. 29, 2008

(30) Foreign Application Priority Data
Sep. 10, 2007 (JP) 2007-233691

(51) Int. Cl. G09G 5/00

(52) U.S. Cl. 345/204

(57) ABSTRACT

A data line driving circuit includes a plurality of blocks that are cascaded together, wherein each of the plurality of blocks includes a shift register that sequentially outputs a plurality of selection signals for each block in synchronization with a clock signal; a data synchronization circuit that adjusts a phase of a data signal in which a plurality of items of data are arranged chronologically by using the clock signal as a reference and to output the data signal to a block of the next stage; a data expansion circuit that expands the items of data of the data signal after being adjusted by the data synchronization circuit into a plurality of systems on the basis of the plurality of selection signals; and a signal generation circuit that generates a driving signal corresponding to each item of data after being expanded by the data expansion circuit.

### BACKGROUND

1. Technical Field

The present invention relates to a technology for expanding a data signal in which a plurality of items of data are arranged chronologically into data of a plurality of systems in synchronization with a clock signal.

2. Related Art

For printers as image forming devices, optical heads for forming electrostatic latent images in an image carrier, such as a photosensitive drum, are used. For active-matrix-type liquid-crystal display devices, display panels for performing image display are used. In optical heads, a plurality of light-emitting elements are arranged in a main scanning direction. As light-emitting elements, electroluminescent (EL) elements, light-emitting diodes, or the like are used. In display panels, liquid-crystal pixels each including a switching element and a liquid-crystal element are arranged in a main scanning direction and in a sub-scanning direction. In the main scanning direction, each liquid-crystal pixel is provided with a data line driving circuit, whereby a process for outputting data to each light-emitting element or each liquid-crystal pixel is performed.

FIG. 17 is a block diagram showing an example of a data line driving circuit. As shown in the figure, a data line driving circuit 420 includes an input latch circuit 421 for sampling a data signal DATA and holding it for a predetermined time period; a shift register 423 for shifting a selection pulse for each clock signal CLK by using a start pulse signal SP as a trigger and for outputting the selection pulse; a line memory 425 for sequentially storing the data signal DATA in synchronization with a selection pulse from the shift register 423 and for holding the data signal DATA in line units; a hold memory 426 for storing data of the line memory 425 that is collectively output on the basis of a latch signal LS; a level shifter 427 for causing the level of the display data signal to match that of a D/A converter 428 at the next stage; a D/A converter 428 for converting a display data signal into an analog voltage on the basis of a reference voltage; and an output circuit 429 that functions as a buffer circuit and that outputs a driving voltage to a light-emitting element circuit array.

Hitherto, a data line driving circuit has been implemented using an IC. In recent years, as disclosed in JP-A-2005-234241 (in particular, see FIG. 1), from the viewpoints of cost reduction, improved reliability due to the reduction in the number of mounted components, and the like, part of the data line driving circuit has been formed using a thin film transistor (TFT).

A data signal DATA output from the input latch circuit 421 is received by the line memory 425 in response to a selection pulse output by the shift register 423. Here, ideally, as shown in FIG. 18A, the relationship between the phase of a selection pulse and the phase of the data signal DATA is preferably such that the phase of the data signal DATA is slightly delayed with respect to the phase of the selection pulse (d1). With such a relationship, a reading period r1 is sufficiently ensured, and thereby the data signal DATA can be reliably received. On the other hand, as shown in FIG. 18B, if the phase of the data signal DATA is significantly delayed with respect to the phase of a selection pulse (d2), a reception period r2 become too short, and a case in which the data signal DATA cannot be received can occur. In order to prevent this, when the phase of the data signal is intentionally made to lead (e1) as shown in FIG. 18C, in the case that data intended to be read is an N-th data signal DATA (N), there is a risk that a case in which a period r3 in which the next (N+1)-th data signal DATA (N+1) is read may occur.

In general, since the capacitive load of the line memory 425 is larger than that of the shift register 423, the data signal DATA tends to become delayed with respect to a selection pulse. When the data line driving circuit is implemented using an IC as in the related art, the driving performance of the input latch circuit 421 can be sufficiently increased and therefore, it has been easy to implement an ideal phase relationship shown in FIG. 18A. However, since a TFT has a driving performance lower than that of an IC, if the input latch circuit 421 is formed using a TFT, the data signal DATA is gradually delayed with respect to the selection pulse. Furthermore, since variations in the amount of delay is large, it is difficult to solve the problem of phase deviation between the selection pulse and the data signal DATA and to reliably receive the data signal DATA. JP-A-2005-234241 discloses that part of the data line driving circuit is formed using a TFT, but it is assumed that the input latch circuit is formed using an IC.

### SUMMARY

An advantage of some aspects of the invention is that the problem of phase deviation between the clock of a selection pulse and data in a data line driving circuit that receives data is solved on the basis of a selection pulse of a shift register.

A data line driving circuit according to a first aspect of the invention includes a plurality of blocks that are cascaded together, wherein each of the plurality of blocks includes a shift register that sequentially outputs a plurality of selection signals for each block in synchronization with a clock signal; a data synchronization circuit that adjusts a phase of a data signal in which a plurality of items of data are arranged chronologically by using the clock signal as a reference and to output the data signal to a block of the next stage; a data expansion circuit that expands the items of data of the data signal after being adjusted by the data synchronization circuit into data of a plurality of systems on the basis of the plurality of selection signals; and a signal generation circuit that generates a driving signal corresponding to each item of data after being expanded by the data expansion circuit.

With the above configuration, a data synchronization circuit is arranged in each of a plurality of blocks for adjusting the phase of a data signal by using a clock signal as a reference. As a consequence, the problem of deviation in a timing between each selection signal and each item of data of a data signal is solved. Therefore, it is possible to reliably expand a data signal by using a data expansion circuit. Furthermore, there is an advantage that, since a clock signal used to generate a selection signal is also used to adjust the phase of a data signal, when compared to the configuration in which generation of a selection signal and adjustment of the phase of a data signal are performed on the basis of separate signals, the configuration of the data line driving circuit and peripheral circuits is simplified.

A data line driving circuit according to a second aspect of the invention includes a plurality of blocks that are cascaded together, wherein each of the plurality of blocks includes a shift register that sequentially outputs a plurality of selection signals for each block in synchronization with a clock signal; a data synchronization circuit that adjusts a phase of a data signal in which a plurality of items of data are arranged chronologically by using as a reference an adjustment clock signal whose phase is delayed with respect to the clock signal and which has the same frequency as that of the clock signal and to output the data signal to a block of the next stage; a data expansion circuit that expands the items of data of the data signal after being adjusted by the data synchronization circuit into data of a plurality of systems on the basis of the plurality of selection signals; and a signal generation circuit that generates a driving signal corresponding to each item of data after being expanded by the data expansion circuit.

With the above configuration, a data synchronization circuit for adjusting the phase of a data signal by using an adjustment clock signal as a reference is arranged in each of a plurality of blocks. Therefore, the problem of deviation in a timing between each selection signal and each item of data of a data signal is solved. Therefore, it is possible to reliably expand a data signal by using a data expansion circuit. Furthermore, the phase of the data signal is adjusted on the basis of the adjustment clock signal delayed with respect to the clock signal. As a consequence, when compared to the configuration in which the clock signal is also used to adjust the phase of the data signal, it is possible to improve the reliability of the expansion of the data signal by using the data expansion circuit.

In the data line driving circuit according to each of the above-described aspects of the invention, the data synchronization circuit adjusts the phase by delaying the data signal, and each of the plurality of blocks includes an adjustment circuit for delaying the timing of the output of each selection signal from the shift register. According to each of the above aspects of the invention, since the timing of the output of each selection signal is delayed by the adjustment circuit, it is possible to solve the problem of deviation in a timing between each selection signal and each item of data of the data signal in spite of the configuration in which the data signal is delayed due to an adjustment by the data synchronization circuit. Furthermore, in a preferred aspect of the invention, the adjustment circuit delays a start pulse in accordance with the clock signal, and the shift register sequentially shifts the start pulse after being delayed by the adjustment circuit in synchronization with the clock signal, thereby generating the plurality of selection signals.

In the data line driving circuit according to the second aspect of the invention, the data synchronization circuit includes a control unit that adjusts the phase by delaying the data signal and that temporarily stops variations in the level of the clock signal so that the timing of the output of the selection signal from the shift register of each of the blocks is delayed. According to the above-described aspect of the invention, since the timing of the output of the selection signal is delayed by the control unit by temporarily stopping variations in the level of the clock signal, it is possible to solve the problem of deviation between each selection signal and each item of data of the data signal in spite of the configuration in which the data signal is delayed due to the adjustment by the data synchronization circuit. Moreover, since the adjustment circuit for delaying a start pulse is unnecessary, there is an advantages that the configuration of the data line driving circuit is simplified.

In a preferred aspect of the invention, each of the plurality of blocks includes a first buffer unit, a second buffer unit, and a third buffer unit whose driving performance is equal. In each of the plurality of blocks, the clock signal is input to the shift register via the first buffer unit, the data signal is input to the data expansion circuit via the second buffer unit, and the adjustment clock signal is input to the data expansion circuit of the block of the next stage via the third buffer unit. According to the above aspects of the invention, since variations in the phase among the clock signal, the adjustment clock signal, and the data signal are suppressed for each block, it is possible to improve the reliability of the expansion of the data signal by the data expansion circuit when compared to the configuration in which the clock signal and the adjustment clock signal are supplied to each block via wiring that is continuous over a plurality of blocks.

An electro-optical apparatus according to an aspect of the invention includes a data line driving circuit according to each of the above aspects of the invention, and a plurality of pixels driven on the basis of each data signal that is output by the data line driving circuit. The electro-optical apparatus according to the aspect of the invention can be adopted, as a display device for displaying images, an exposure device for exposing an image carrier (for example, a photosensitive drum) or the like, in various kinds of electronic apparatuses.

### BRIEF DESCRIPTION OF THE DRAWINGS

The invention will be described with reference to the accompanying drawings, wherein like numbers reference like elements.

FIG. 1 is a perspective view showing the configuration of part of an image forming device using an optical head including a data line driving circuit of the invention.

FIG. 2 is a block diagram showing the electrical configuration of a light-emitting device.

FIG. 3 is a block diagram showing the configuration of a data line driving circuit according to a first embodiment of the invention.

FIG. 4 is a circuit diagram showing an example of the configuration of a shift register, a line memory, and a hold memory.

FIG. 5 is a timing chart illustrating the operation of the data line driving circuit,

FIG. 6 is a block diagram showing an example of the configuration of a data synchronization circuit.

FIG. 7 is a timing chart illustrating the operation of the data synchronization circuit.

FIG. 8 is a block diagram showing another example of the configuration of the data synchronization circuit.

FIG. 9 is a circuit diagram showing an example of the configuration of a shift register, a line memory, and a hold memory in a case in which two data signal lines are used.

FIG. 10 is a block diagram showing the configuration of a data line driving circuit according to a second embodiment of the invention.

FIG. 11 is a block diagram showing the configuration of a data line driving circuit according to a third embodiment of the invention.

FIG. 12 is a timing chart illustrating the operation of the data line driving circuit.

FIG. 13 is a block diagram showing the configuration of a data line driving circuit according to a fourth embodiment of the invention.

FIG. 14 is a longitudinal sectional view showing an example of an image forming device.

FIG. 15 is a longitudinal sectional view showing another example of the image forming device.

FIG. 16 is a block diagram showing the configuration of a display device.

FIG. 17 is a block diagram showing the configuration of a data line driving circuit of the related art.

FIGS. 18A, 18B, and 18C are timing charts showing the relationship between a selection pulse and a data signal.

### DESCRIPTION OF EXEMPLARY EMBODIMENTS

Various embodiments of the invention will be described with reference to the drawings. Components common throughout the figures are designated with the same reference numerals.

### 1. First Embodiment

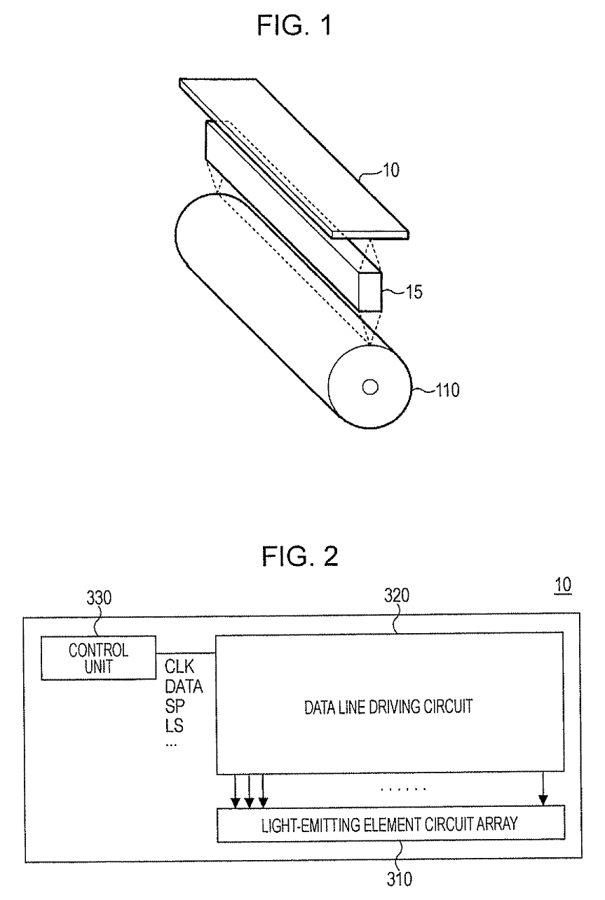

FIG. 1 is a perspective view showing the partial configuration of an image forming device in which a light-emitting device 10 including a data line driving circuit according to an embodiment of the invention is used as an optical head (exposure device). As shown in the figure, the image forming device includes the light-emitting device 10, a collective lens array 15, and a photosensitive drum 110. The light-emitting device 10 includes a plurality of light-emitting elements. Light is emitted from the light-emitting element. This light emission is selectively performed in accordance with the mode of an image to be printed in a recording material, such as printing paper. These lights travel to the collective lens array 15. The photosensitive drum 110 is supported by the rotation shaft extending in the main scanning direction, and is rotated in the sub-scanning direction (in the direction in which the recording material is transported) in a state in which the outer peripheral surface thereof faces the light-emitting device 10).

The collective lens array 15 is arranged in the clearance between the light-emitting device 10 and the photosensitive drum 110. The collective lens array 15 includes many gradient index lenses arranged in an array form in a posture with each of the optical axes thereof directed toward the light-emitting device 10. Emission light from each light-emitting element of the light-emitting device 10 passes through each gradient index lens of the collective lens array 15 and reaches the surface of the photosensitive drum 110. Exposure caused thereby causes a latent image (electrostatic latent image) corresponding to a desired image to be formed on the surface of the photosensitive drum 110.

FIG. 2 is a block diagram showing the electrical configuration of the light-emitting device 10. As shown in FIG. 2, the light-emitting device 10 includes a light-emitting element circuit array 310, a data line driving circuit 320, and a control unit 330. The light-emitting element circuit array 310 includes many light-emitting elements arranged in a line form or in a plane form. The data line driving circuit 320 drives each light-emitting element by generating and outputting a driving signal. The data line driving circuit 320 of this embodiment is configured to include TFTs formed on the surface of an insulating substrate. The control unit 330 outputs various kinds of signals (a clock signal CLK, a data signal DATA, a start pulse signal SP, and a latch signal LS), thereby controlling the data line driving circuit 320.

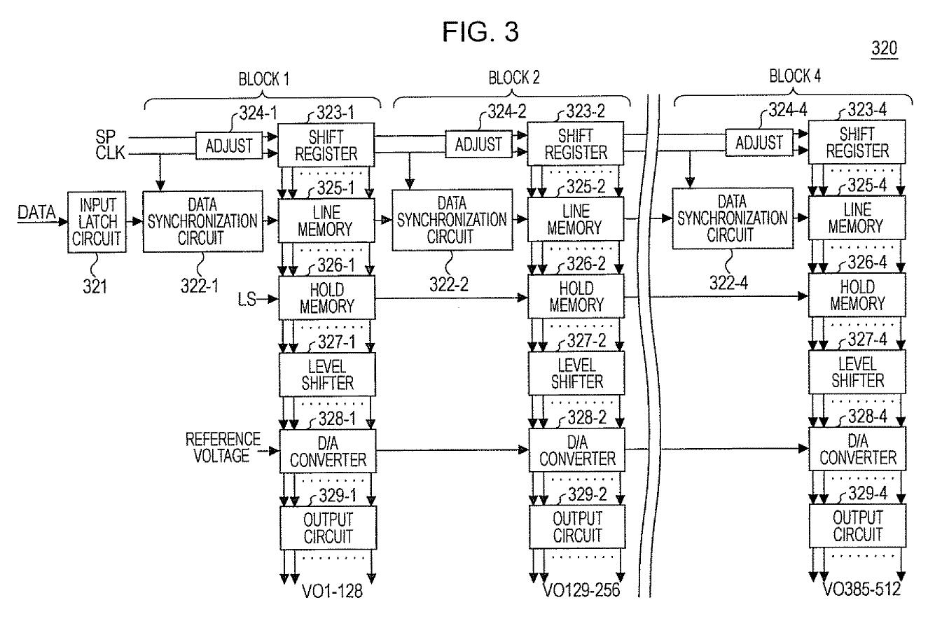

FIG. 3 is a block diagram showing the configuration of the data line driving circuit 320. The data line driving circuit 320, which is formed of an input latch circuit 321 and a plurality of blocks (blocks 1 to 4), generates a plurality of driving signals VO (VO1 to VO512). The input latch circuit 321 latches a data signal DATA input from the control unit 330. The data signal DATA are signals in which data that specifies the gray scale (amount of light) of light-emitting elements is arranged chronologically in synchronization with a clock signal CLK.

The blocks 1 to 4 are cascaded together. Each block i (i=1 to 4) includes a data synchronization circuit 322-i, a shift register 323-i, an adjustment circuit 324-i, a line memory 325-i, a hold memory 326-i, a level shifter 327-i, a D/A converter 328-i, and an output circuit 329-i.

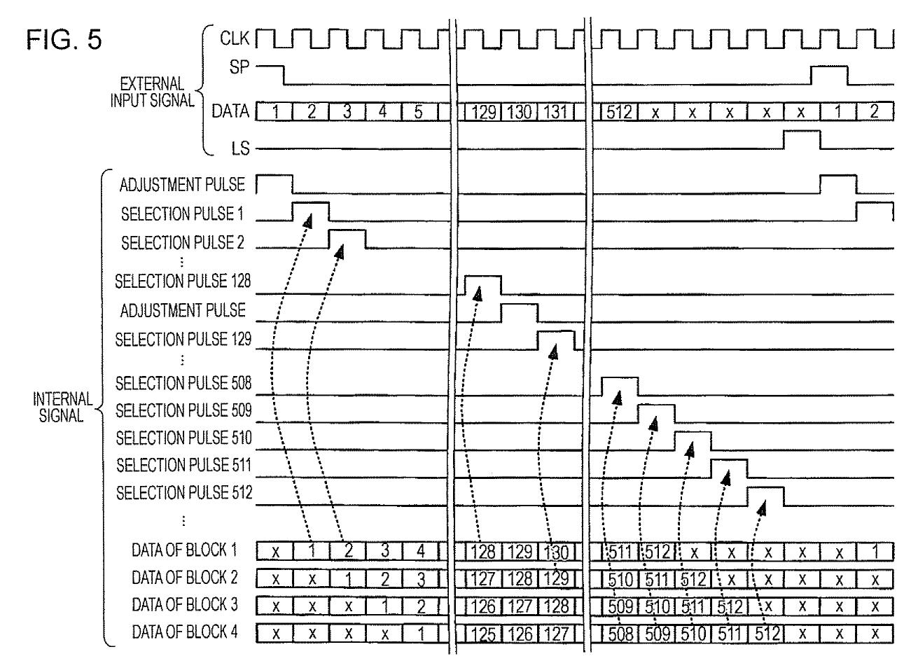

The shift register 323-i sequentially shifts a start pulse signal SP in synchronization with the clock signal CLK, thereby outputting a plurality of selection pulses (selection pulses of 128 systems in this embodiment). As shown in FIG. 5, a start pulse signal SP is supplied to the shift register 323-1 of the block 1 in a predetermined period from the control unit 330 via the adjustment circuit 324-1. A selection pulse at the final stage in each shift register 323-i is input as a start pulse signal SP to the block i+1 of the next stage. Therefore, as shown in FIG. 5, selection pulses of 512 systems are sequentially output for each block from the shift registers 323-1 to 323-4. The line memory 325-i expands each item of data of the data signal DATA into data of a plurality of systems (128 systems) on the basis of each selection pulse output by the shift register 323-i and holds the data. The hold memory 326-i simultaneously outputs the data of the 128 systems expanded by the line memory 325-i on the basis of the latch signal LS.

The level shifter 327-i adjusts the level of each output from the hold memory 326-i so as to cause it to match the operating voltage of the D/A converter 328. The D/A converter 328-i converts the data after being converted by the level shifter 327-i into an analog voltage. The output circuit (buffer circuit) 329-i generates a driving signal VO corresponding to each output from the D/A converter 328-i, and outputs the driving signal VO. The level shifter 327-i, the D/A converter 328-i, and the output circuit 329-i function as a circuit (signal generation circuit) for generating a driving signal VO corresponding to each item of data after being expanded by the line memory 325-i.

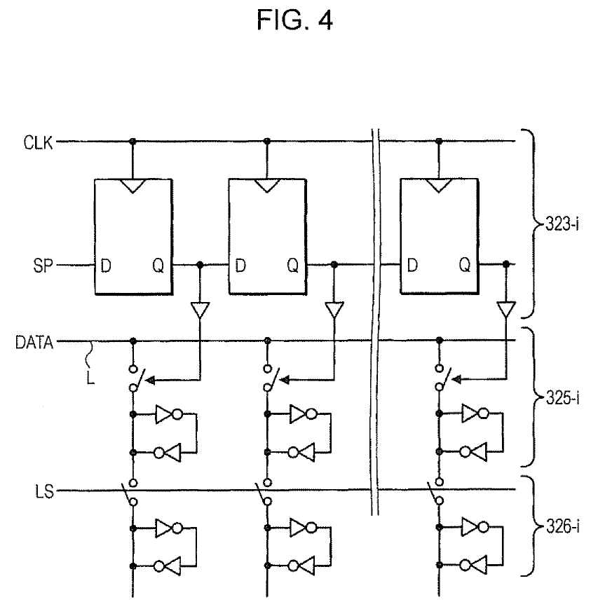

FIG. 4 is a circuit diagram showing an example of the configuration of the shift register 323-i, the line memory 325-i, and the hold memory 326-i. As shown in FIG. 4, the shift register 323-i is formed of a plurality of D latches in which the output terminal Q of each stage is connected to the input terminal D of the next stage. The start pulse signal SP is supplied to the input terminal D of the D latch of the first stage, and a common clock signal CLK is supplied to each D latch. Furthermore, the line memory 325-i is composed of a switch whose on/off states are controlled on the basis of a selection pulse output from each D latch, and a storage element in which two inverters are loop-connected, and expands a data signal DATA of one system supplied to the data signal line L in synchronization with the output of the D latch into data signals of a plurality of systems and holds the data signals DATA. The hold memory 326-i is formed of a switch whose on/off states are controlled in accordance with a latch signal LS, and a storage element in which two inverters are loop-connected, and simultaneously receives data held by the line memory 325 at a timing specified by the latch signal LS.

The data synchronization circuit 322-i of FIG. 3 is a circuit for achieving synchronization between the clock signal CLK and the data signal DATA. More specifically, the data synchronization circuit 322-i receives the data signal DATA and the clock signal CLK, and adjusts the phase of the data signal DATA so that the data signal DATA delayed with respect to the time (N) of the fall of the clock signal CLK is synchronized at the point in time (N+1) of the next fall of the clock signal CLK. The data signal DATA after being adjusted by the data synchronization circuit 322-i is supplied to the line memory 325-i via a data signal line L, and is also input to the data synchronization circuit 322-i+1 of the block of the next stage.

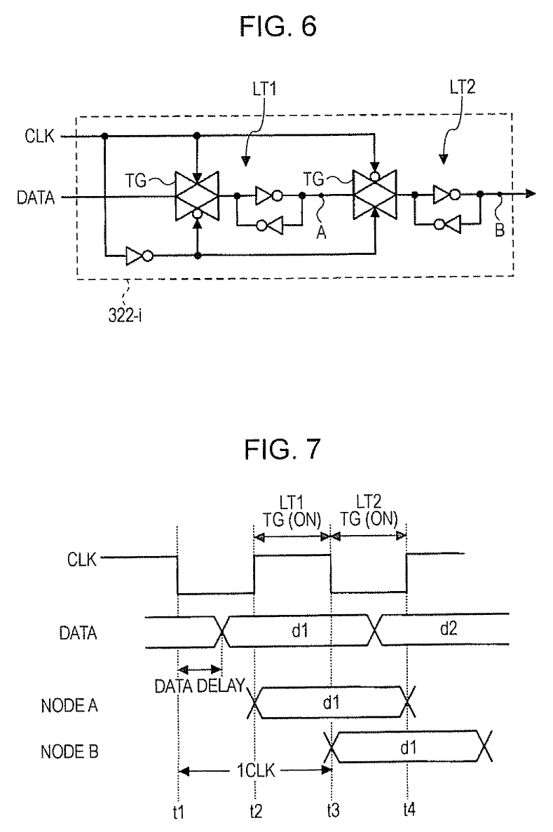

FIG. 6 is a block diagram showing an example of the configuration of the data synchronization circuit 322-i. As shown in the figure, the data synchronization circuit 322-i is configured in such a manner that latches LT1 and LT2, which are each formed of a transfer gate TG and two inverters which are loop-connected, are master/slave connected. The data signal DATA is supplied to the input terminal of the transfer gate TG of the latch LT1, and the output terminal of the latch LT2 is connected to the data signal line L. When one of the transfer gate TG of the latch LT1 and the transfer gate TG of the latch LT2 is controlled to be an on state, the other becomes an off state.

FIG. 7 is a timing chart illustrating the operation of the data synchronization circuit 322-i shown in FIG. 6. In FIG. 7, a case is assumed in which the data signal DATA immediately before being input to the data synchronization circuit 322-i is delayed with respect to an expected point in time t1 of the clock signal CLK.

As shown in FIG. 7, when the clock signal CLK rises at a point in time t2, the transfer gate TG of the latch LT1 is turned on. Therefore, the data signal DATA (d1) is received and held by the latch LT1, and the output value of a node A, which is the output end of the latch LT1, becomes d1.

When the clock signal CLK falls at a point in time t3, the transfer gate TG of the latch LT2 is turned on. Therefore, the output value d1 of the node A is received and held by the latch LT2, and the output value of a node B, which is the output end (the output end of the data synchronization circuit 322) of the latch LT2, becomes d1. That is, in the data synchronization circuit 322, the data signal DATA is received at the rise time of the clock signal CLK, and furthermore, the data signal DATA is output delayed by an amount equal to a half-period of the clock signal CLK. Therefore, when viewed from the original point in time t1 at which the data signal DATA should be set to the data d1, the data signal DATA output from the data synchronization circuit 322 is output in synchronization with clock signal CLK in a state in which the data signal DATA is delayed by an amount equal to one period (one CLK in FIG. 7) of the clock signal CLK.

As can be understood from FIG. 7, it is possible for the data synchronization circuit 322 to adjust the delay of the data signal DATA within an amount equal to a half-period of the clock signal CLK. Since the data signal DATA is delayed as a result of the signal transmission of the data signal line L, even if the data signal DATA and the clock signal CLK are synchronized with each other at the topmost stage of the line memory 325-i, the lower the stage of the line memory 325-i, the more the data signal DATA is delayed. The larger the number of stages of the line memory 325-i, the more the data signal DATA is delayed. Therefore, it is preferable that the number of stages (128 stages in this embodiment) of each block is determined in such a manner that the amount of delay of the data signal DATA with respect to the clock signal CLK falls within a half period of the clock signal CLK.

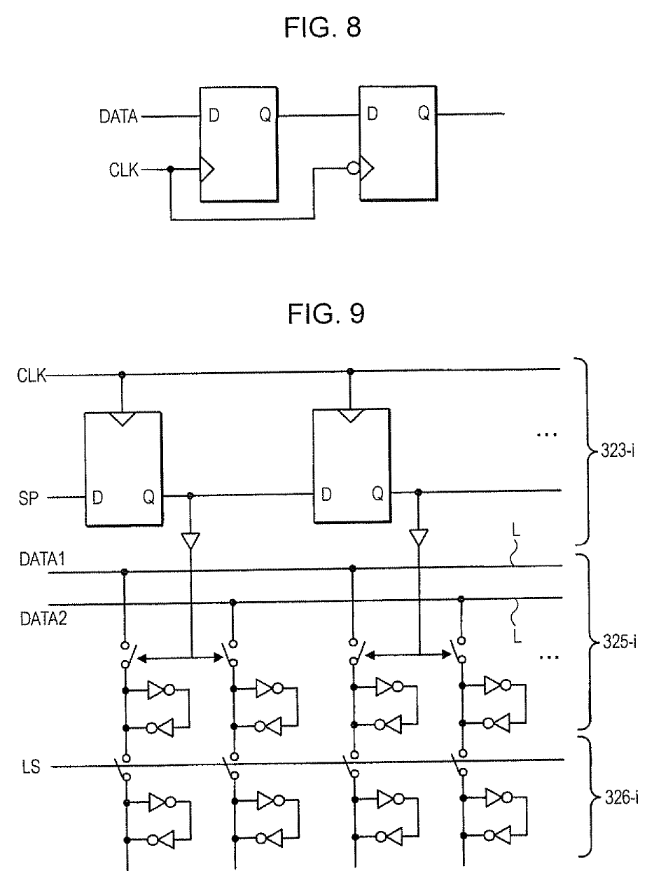

The configuration of the data synchronization circuit 322 is not limited to the example of FIG. 6. For example, as shown in FIG. 8, the data synchronization circuit 322 may be configured in such a manner that two D latches are master/slave connected. Also, in the configuration of FIG. 8, the D latch on the master side receives input data with a delay of a half clock, and the D latch on the slave side outputs the data with a delay of one clock period. Therefore, similarly to the configuration of FIG. 6, the data signal DATA delayed so as to be synchronized with the clock signal CLK is output.

As has thus been described above, since the data synchronization circuit 322-i delays the data signal DATA, the adjusted data signal DATA is delayed by an amount equal to one period of the clock signal CLK with respect to the start pulse signal SP input to the block i (the adjustment circuit 324-i). The adjustment circuit 324-i delays the start pulse signal SP on the basis of the clock signal CLK, thereby compensating for the delay of the data signal DATA with respect to the start pulse signal SP. For example, a shift register of one stage is adopted as the adjustment circuit 324-i. By delaying the start pulse signal SP in the manner described above, each selection pulse of the shift register 323 is delayed by an amount equal to one period of the clock signal CLK. Therefore, the data signal DATA and each selection pulse of the shift register 323 are synchronized with each other. That is, for example, as shown in FIG. 5 when data (1) that specifies a driving signal VO1 of the first stage is being supplied as a data signal DATA to the data signal line L, a selection pulse 1 of the first stage is output from the shift register 323-1.

Next, a description will be given, with reference to FIG. 5, the operation of the data line driving circuit 320. FIG. 5 shows an adjustment pulse that is generated as a start pulse signal SP of the shift register 323-i by the adjustment circuit 324-i of each stage in addition to signals (the clock signal CLK, the start pulse signal SP, the data signal DATA, and the latch signal LS) output by the control unit 330; selection pulses (selection pulses 1 to 512) of 512 systems, which are output by the shift registers 323-1 to 323-4; and the data signal DATA after being adjusted by the data synchronization circuit 322-i of each block i. In FIG. 5, a case in which the adjusted data signal DATA and the clock signal CLK are completely synchronized with each other is shown as an example for the sake of convenience. In practice, in order that the data signal DATA is reliably received, the data synchronization circuit 322 is configured so that the data signal DATA is slightly delayed with respect to the clock signal CLK.

The data signal DATA input from the control unit 330 to the data line driving circuit 320 is delayed as a result of passing through the input latch circuit 321, but is synchronized with the clock signal CLK by the data synchronization circuit 322-1 provided at the beginning of the block 1. At this time, in the block 1, the data signal DATA is delayed by an amount equal to one period of the clock signal CLK. However, since the adjustment pulse after being delayed by the adjustment circuit 324-1 is input as a start pulse signal SP to the shift register 323-1, the data signal DATA (1) is received by the first stage of the line memory 325-1 on the basis of the selection pulse 1 output at the next clock. Hereinafter, the data signals DATA (2) to (128) are sequentially received for each clock signal CLK by the line memory 325-1 of the block 1.

The data signal DATA is delayed as a result of the signal transmission of the data signal line L in the block 1. A data synchronization circuit 322-2 provided at the beginning of the block 2 delays the data signal DATA so as to be synchronized with the clock signal CLK. On the other hand, since the adjustment pulse with which the selection pulse 128 is delayed by an amount equal to one period of the clock signal CLK is input as a start pulse signal SP to the shift register 323-2, a data signal DATA (129) is received by the first stage of the line memory 325-2 on the basis of the selection pulse 129. Hereinafter, the data signals DATA (129) to (256) are sequentially received for each clock signal CLK by the line memory 325-2 of the block 2.

As a result of the same operations as the above being performed on the blocks 3 and 4, when data signals DATA (257) to (384) are held in the line memory 325-3 and also data signals DATA (385) to (512) are held in the line memory 325-4, a common latch signal LS is output from the control unit 330 to the blocks 1 to 4, and the data held in the line memories 325-1 to 325-4 is simultaneously output from the hold memories 326-1 to 326-4. Thereafter, a new start pulse signal SP is input from the control unit 330 to the block 1, and processing for the next data signal DATA is performed in a similar manner.

As has thus been described above, in this embodiment, the data synchronization circuit 322-i is disposed for each block in which the data line driving circuit 320 is divided. Therefore, the problem of a delay of the data signal DATA, which occurs in the input latch circuit 321, and the problem of a delay of the data signal DATA in each block i are solved for each block. Therefore, it is possible to effectively prevent a malfunction of the data line driving circuit 320, which results from a deviation in a timing between the data signal DATA and each selection pulse. Furthermore, since the timing of the output of each selection pulse is adjusted by the adjustment circuit 324-i, even though the data synchronization circuit 322-i delays the data signal DATA, it is possible to appropriately expand each item of data of the data signal DATA and store it in the line memory 325-i.

In FIGS. 3 and 4, a configuration in which the number of data signal line L through which the data signal DATA is transmitted is one is shown as an example for the sake of convenience. In practice, a configuration is preferable in which data signals DATA for a plurality of systems are transmitted in parallel via a plurality of data signal lines L. FIG. 9 is a circuit diagram showing an example of the configuration of the shift register 323, the line memory 325, and the hold memory 326 in a case in which data signals DATA1 and DATA2 of two systems are transmitted in parallel by using two data signal lines L. Switches adjacent to each other in the line memory 325-i are controlled in accordance with a common selection pulse. An odd-numbered switch receives a data signal DATA1, and an even-numbered switch receives a data signal DATA2. Furthermore, in this embodiment, a latch part for temporarily holding data is configured in such a manner that two inverters are loop-connected for the sake of simplicity of description, but is not limited to this example. For example, one of the inverters may be formed as a clocked inverter so that input data does not compete.

### 2. Second Embodiment

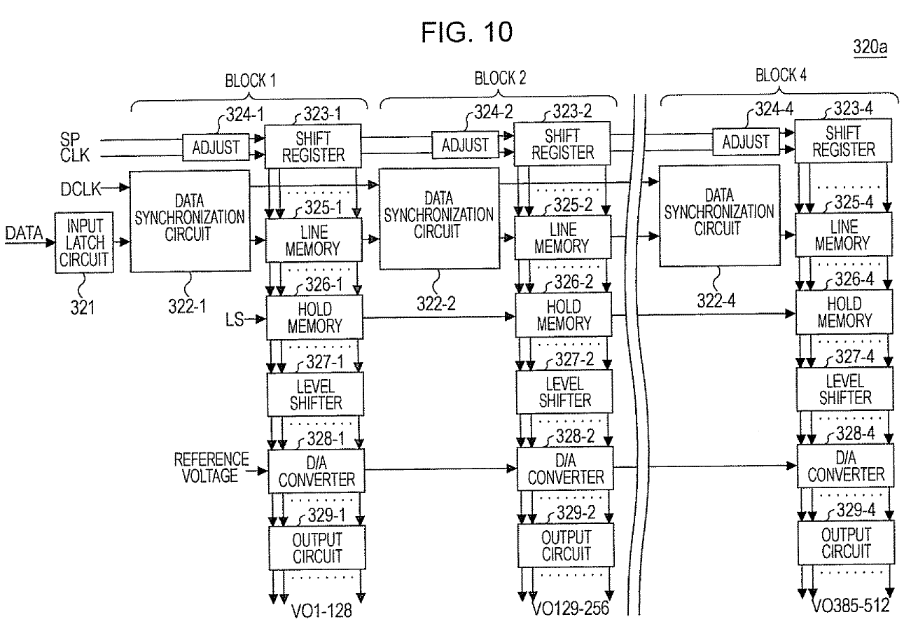

Next, a second embodiment of the invention will be described below. FIG. 10 is a block diagram showing the configuration of a data line driving circuit 320a according to the second embodiment of the invention. Components having the same operations and functions as those of the first embodiment are designated with the same reference numerals.

In the first embodiment, the clock signal CLK is used for both the shift of the selection pulse in the shift register 323-i and the adjustment of the phase of the data signal DATA in the data synchronization circuit 322-i. In the second embodiment, whereas the clock signal CLK IS supplied to the shift register 323-i, an adjustment clock signal DCLK separate from the clock signal CLK is supplied to the data synchronization circuit 322-i. The clock signal CLK and the adjustment clock signal DCLK have the same frequency, and the adjustment clock signal DCLK is a signal whose phase is slightly delayed with respect to the clock signal CLK. The remaining construction is the same as that of the first embodiment.

As described above, in this embodiment, since the difference in the phases between the adjustment clock signal DCLK and the clock signal CLK can be set as desired, in the line memory 325-i, it is possible to create an ideal relationship in which the data signal DATA is slightly delayed with respect to a selection pulse. Therefore, it is possible to reliably receive the data signal DATA into the line memory 325-i.

In this embodiment, in order that a delay difference resulting from electric characteristics of wiring does not occur between the clock signal CLK and the adjustment clock signal DCLK, the wiring is designed and formed so that loads of signal lines through which signals are transmitted become substantially equal to each other. Making a layout so that loads become substantially equal to each other between the clock signal line and the data signal line L is generally difficult. However, the layout can be easily implemented between clock signal lines.

### 3. Third Embodiment

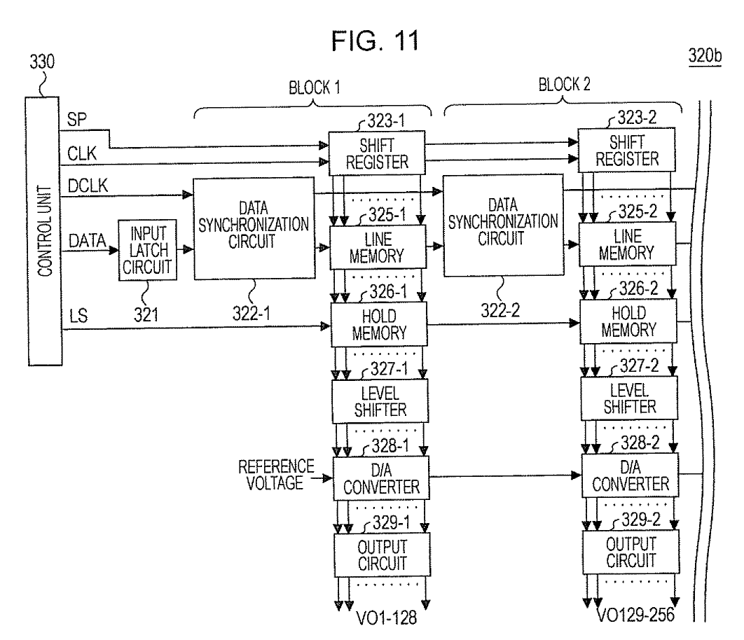

Next, a third embodiment of the invention will be described below. FIG. 11 is a block diagram showing the configuration of a data line driving circuit 320b according to the third embodiment of the invention. Components having the same operations and functions as those of the second embodiment are designated with the same reference numerals. In the first and second embodiments, the problem of the delay of the data signal DATA with respect to the start pulse signal SP is solved by the adjustment circuits 324-1 to 324-4. In the third embodiment, as shown in FIG. 11, the adjustment circuits 324-1 to 324-4 are omitted, and the control unit 330 stops variations in the level of the clock signal CLK by an amount equal to one period, thereby solving the delay of the data signal DATA with respect to the start pulse signal SP (or each selection pulse).

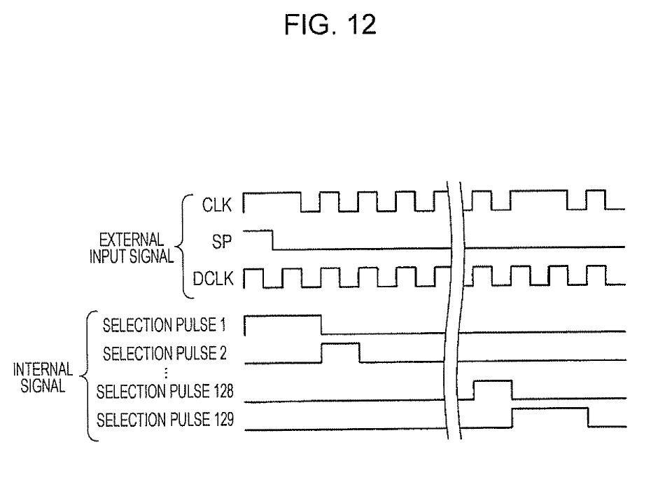

FIG. 12 is a timing chart illustrating the operation of the data line driving circuit 320b in this embodiment. As shown in FIG. 12, in the first and second embodiments, the control unit 330 stops variations in the level of the clock signal CLK by an amount equal to one period at a timing at which the adjustment circuit 324-i outputs an adjustment pulse (that is, immediately before the selection pulse at the beginning of each block is output). As a result, since the shift operation by the shift register 323-i is stopped once, the selection pulse is delayed by an amount equal to one period of the clock signal CLK with respect to the start pulse signal SP. Therefore, similarly to the first and second embodiments, it is possible to solve the problem of delay of the data signal DATA with respect to the start pulse signal SP. According to this embodiment, since the adjustment circuits 324-1 to 324-4 are unnecessary, the circuit scale of the data line driving circuit 320 can be reduced compared to the first and second embodiments.

### 4. Fourth Embodiment

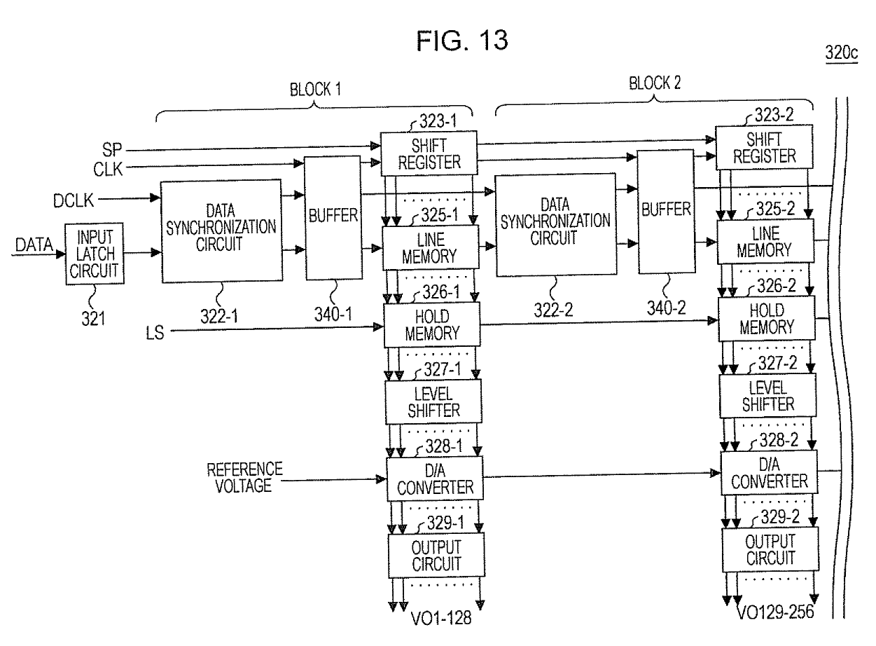

Next, a fourth embodiment of the invention will be described below. FIG. 13 is a block diagram showing the configuration of a data line driving circuit 320c according to the fourth embodiment of the invention. As shown in the figure, the data line driving circuit 320c is configured in such a manner that a buffer 340-i is disposed in each block i of the data line driving circuit 320b of the third embodiment. The buffer 340-i is arranged at a stage before the shift register 323-i and the line memory 325-i.

The buffer 340-i includes a first buffer unit, a second buffer unit, and a third buffer unit. A clock signal CLK is supplied to the shift register 323-i via the first buffer unit. In more detail, the clock signal CLK is supplied to the shift register 323-1 from the control unit 330 via the first buffer unit, and the clock signal CLK is supplied to the first buffer unit of each of the blocks 2 to 4 from the first buffer unit of the block of the preceding stage. The data signal DATA is supplied to the line memory 325-i via the second buffer unit via a data synchronization circuit 322-i. Furthermore, the adjustment clock signal DCLK passing through the data synchronization circuit 322-i is supplied to the data synchronization circuit 322-i+1 of the block of the next stage via the third buffer unit. The first buffer unit, the second buffer unit, and the third buffer unit have a nearly equal driving performance.

In the second and third embodiments, each of the clock signal CLK and the adjustment clock signal DCLK is supplied to all the blocks via one clock signal line. When the wiring length of each clock signal line is long, there is a possibility that the clock signal CLK and the adjustment clock signal DCLK are delayed due to an increase in the parasitic capacity. According to this embodiment, since a buffer unit having an equal performance is arranged in the path for the clock signal CLK and the adjustment clock signal DCLK in each block, the delays of the clock signal CLK and the adjustment clock signal DCLK are suppressed. Therefore, a deviation in the synchronization between the clock signal CLK and the data signal DATA can be prevented, and it is possible to reliably receive the data signal DATA into the line memory 325-i.

### 5. Image Forming Device

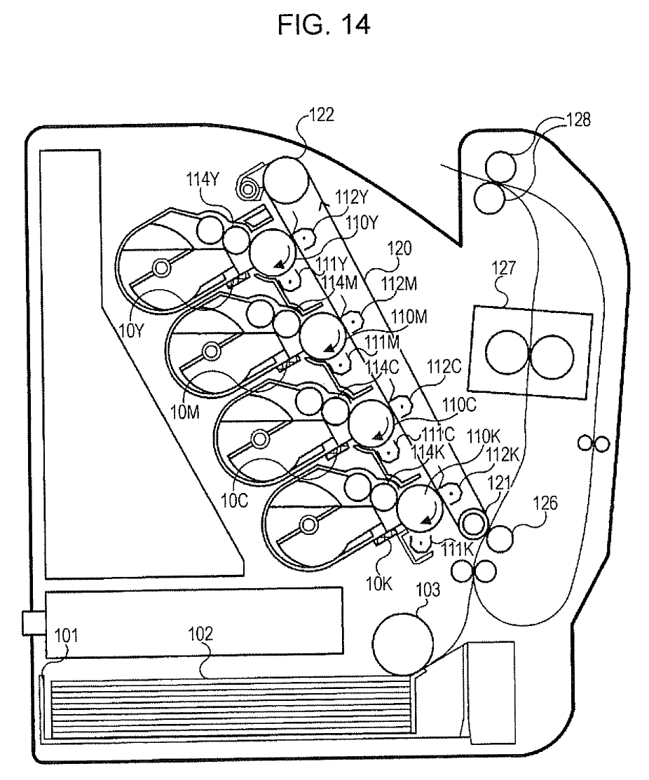

The light-emitting device 10 according to each of the embodiments can be used as a line-type optical head for writing a latent image in an image carrier in the image forming device using an electrophotographic method. Examples of the image forming device include a printer, the print part of a copying machine, and the print part of a facsimile. FIG. 14 is a longitudinal sectional view showing an example of an image forming device in which the light-emitting device 10 is used as a line-type optical head. The image forming device is a tandem-type full-color image forming device using a belt intermediate transfer body method.

In the image forming device, four organic EL arrays 10K, 10C, 10M, and 10Y having an identical configuration are arranged at the exposure positions of four photosensitive drums (image carriers) 110K, 110C, 110M, and 110Y having an identical configuration, respectively. The organic EL arrays 10K, 10C, 10M, and 10Y are each a light-emitting device 10 according to one of the embodiments exemplified above.

As shown in FIG. 14, the image forming device is provided with a driving roller 121 and a follower roller 122. An intermediate transfer belt 120 with no end is wound around the rollers 121 and 122, and the intermediate transfer belt 120 is rotated about the rollers 121 and 122, as indicated by the arrow. Although not shown in the figure, tension providing means, such as a tension roller, for providing tension to the intermediate transfer belt 120, may be provided.

Around the intermediate transfer belt 120, four photosensitive drums 110K, 110C, 110M, and 110Y having a photosensitive layer on their outer peripheral surface are arranged at predetermined intervals. Subscripts K, C, M, and Y indicate uses for forming black, cyan, magenta, and yellow visible images, respectively. This also applies to the other members. The photosensitive drums 110K, 110C, 110M, and 110Y are rotationally driven in synchronization with the driving of the intermediate transfer belt 120.

Around each of the photosensitive drums 110 (K, C, M, Y), corona chargers 111 (K, C, M, Y) and organic EL arrays 10 (K, C, M, Y), and developing units 114 (K, C, M, Y) are arranged, respectively. The corona charger 111 (K, C, M, ands Y) causes the outer peripheral surface of the corresponding photosensitive drum 110 (K, C, M, Y) to be electrically charged uniformly. The organic EL arrays 10 (K, C, M, Y) writes an electrostatic latent image on the electrically charged outer peripheral surface of the photosensitive drum. The organic EL arrays 10 (K, C, M, Y) are each disposed in such a manner that the arrangement direction of a plurality of light-emitting elements P is along the bus (main scanning direction) of the photosensitive drums 110 (K, C, M, Y). Writing of an electrostatic latent image is performed by irradiating the photosensitive drum with light by the plurality of light-emitting elements P described above. The developing units 114 (K, C, M, Y) cause toner as a developing agent to be adhered to an electrostatic latent image, thereby forming a visual image, that is, a visible image on the photosensitive drum.

Each of the black, cyan, magenta, and yellow visible images formed by such single-color visible image-formation station of four colors is sequentially subjected to primary transfer on the intermediate transfer belt 120, thereby being overlaid on the intermediate transfer belt 120. As a result, a full-color visible image is obtained. Inside the intermediate transfer belt 120, four primary transfer corotrons (transfer units) 112 (K, C, M, Y) are arranged. The primary transfer corotrons 112 (K, C, M, Y) are arranged in the vicinity of the photosensitive drums 110 (K, C, M, Y), respectively. By electrostatically attracting a visible image from the photosensitive drums 110 (K, C, M, Y), the visible image is transferred onto the intermediate transfer belt 120 that is passed through the photosensitive drum and the primary transfer corotron.

A sheet 102 for which an image is formed finally is conveyed one by one from a paper-feed cassette 101 by means of a pick-up roller 103, and is sent to a nip between the intermediate transfer belt 120 in contact with the driving roller 121 and the secondary transfer roller 126. The full-color visible image on the intermediate transfer belt 120 is secondarily transferred collectively on one side of the sheet 102 by the secondary transfer roller 126, and passes through a fixing roller pair 127, which is a fixing unit, thereby being fixed on the sheet 102. Thereafter, the sheet 102 is ejected on the paper-ejection cassette formed in the upper portion of the device by a paper-ejection roller pair 128.

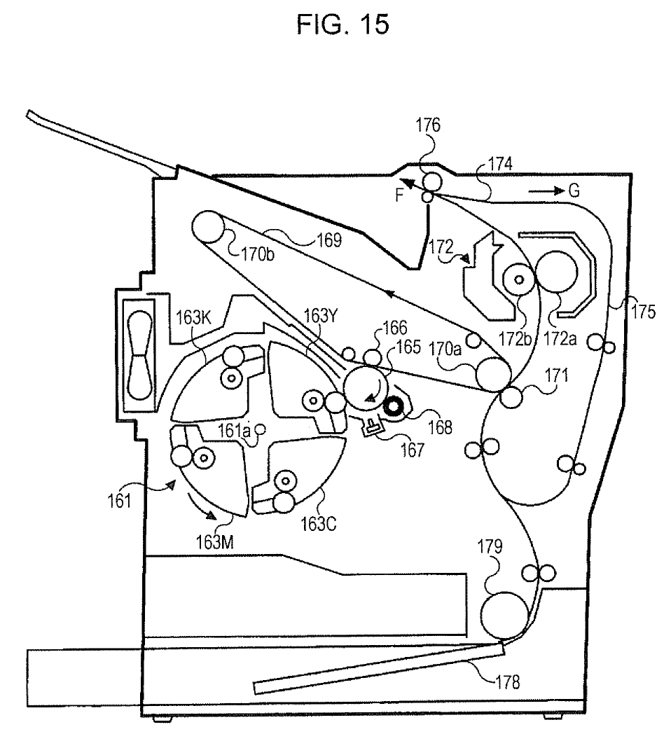

Next, another embodiment of the image forming device according to the invention will be described below. FIG. 15 is a longitudinal sectional view of another image forming device in which the light-emitting device 10 is used as a line-type optical head. This image forming device is a full-color image forming device of a rotary development type using a belt intermediate transfer body method. In the image forming device shown in FIG. 15, a corona charger 168, a rotary-type developing unit 161, an organic EL array 167, and an intermediate transfer belt 169 are provided around a photosensitive drum 165.

The corona charger 168 causes the outer peripheral surface of the photosensitive drum 165 to be electrically charged uniformly. The organic EL array 167 writes an electrostatic latent image on the electrically charged outer peripheral surface of the photosensitive drum 165. The organic EL array 167 includes optical heads 10 and 10A of each embodiment exemplified above, and is disposed in such a manner that the arrangement direction of the plurality of light-emitting elements P is along the bus (main scanning direction) of the photosensitive drum 165. The writing of the electrostatic latent image is performed by irradiating the photosensitive drum 165 with light from these light-emitting elements P.

The developing unit 161 is a drum in which four developing units 163Y, 163C, 163M, and 163K are arranged at intervals of 90°, and is rotatable about an axis 161a in a counterclockwise manner. The developing units 163Y, 163C, 163M, and 163K supply yellow, cyan, magenta, and black toner to the photosensitive drum 165, respectively, and causes the toner serving as a developing agent to be adhered to the electrostatic latent image, thereby forming a visual image, that is, a visible image on the photosensitive drum 165.

The intermediate transfer belt 169 with no end is wound around the driving roller 170a, the follower roller 170b, the primary transfer roller 166, and the tension roller, and is rotated around these rollers in the direction indicated by the arrow. The primary transfer roller 166 electrostatically attracts a visible image from the photosensitive drum 165 and thereby transfers the visible image on the intermediate transfer belt 169 passing between the photosensitive drum and the primary transfer roller 166.

More specifically, at the first one rotation of the photosensitive drum 165, an electrostatic latent image for a yellow (Y) image is written by the organic array 167, and the visible image of the same color is formed by the developing unit 163Y and is further transferred to the intermediate transfer belt 169.

Furthermore, at the next one rotation, an electrostatic latent image for a cyan (C) image is written by the organic array 167, and a visible image of the same color is formed by the developing unit 163C and is transferred to the intermediate transfer belt 169 in such a manner as to be overlaid on the yellow visible image. Then, while the photosensitive drum 165 is rotated four times in this manner, yellow, cyan, magenta, and black visible images are sequentially overlaid on the intermediate transfer belt 169 and, as a result, a full-color visible image is formed on the transfer belt 169. When images are to be formed on both sides of a sheet on which images are formed finally, a full-color visible image is obtained on the intermediate transfer belt 169 in such a manner that a visible image of the same color of the obverse surface and the reverse surface is transferred to the intermediate transfer belt 169 and a visible image of the next color of the obverse surface and the reverse surface is transferred to the intermediate transfer belt 169.

The image forming device is provided with a sheet transport path 174 through which sheets are passed. Sheets are taken out one by one from the paper-feed cassette 178 by means of a pick-up roller 179, are moved through the sheet transport path 174 by a transportation roller, and are passed through a nip between the intermediate transfer belt 169 in contact with the driving roller 170a and a secondary transfer roller 171. The secondary transfer roller 171 collectively attracts a full-color visible image from the intermediate transfer belt 169 in an electrostatic manner, thereby transferring the visible image to one side of the sheet. The secondary transfer roller 171 can be made to be in contact with and separated from the intermediate transfer belt 169 by means of a clutch (not shown). Then, when a full-color visible image is to be transferred to the sheet, the secondary transfer roller 171 is brought into abutment with the intermediate transfer belt 169, and while the visible image is overlaid on the intermediate transfer belt 169, the intermediate transfer belt 169 is separated from the secondary transfer roller 171.

The sheet to which an image is transferred in the manner described above is transported to the fixing unit 172, and is passed between a heating roller 172a and a pressure roller 172b of the fixing unit 172, thereby causing the visible image on the sheet to be fixed. The sheet after the fixing process is pulled in by the paper-ejection roller pair 176 and is moved in the direction of the arrow F. In the case of a both-sided print, after most of the sheet is passed through the paper-ejection roller pair 176, the paper-ejection roller pair 176 is rotated in a reverse direction, and is guided to a transport path 175 for both-sided print as indicated by an arrow G. Then, the visible image is transferred to the other surface of the sheet by the secondary transfer roller 171. After a fixing process is performed by the fixing unit 172 again, the sheet is ejected by the paper-ejection roller pair 176.

Since the image forming device exemplified in FIGS. 14 and 15 uses light-emitting elements as exposure means, the size of the device can be reduced more than in a case in which a laser scanning optical system is used. The optical head according to the embodiment of the invention can be adopted in an image forming device of an electrophotographic method other than that exemplified above. For example, the optical head according to the embodiment of the invention can be applied to an image forming device of a type in which a visible image is directly transferred to a sheet from the photosensitive drum without using an intermediate transfer belt and to an image forming device for forming monochrome images.

The image forming device to which the light-emitting device according to the embodiment of the invention is applied is not limited to an image forming device. For example, for an illumination device in various kinds of electronic apparatuses, an optical head in which functions of the data line driving circuit 320 according to the invention are applied is adopted. Examples of such electronic apparatuses include a facsimile, a copying machine, a multi-function unit, and a printer. For these electronic apparatuses, an optical head in which a plurality of light-emitting elements are arranged in a plane form is suitably adopted.

### 6. Display Device

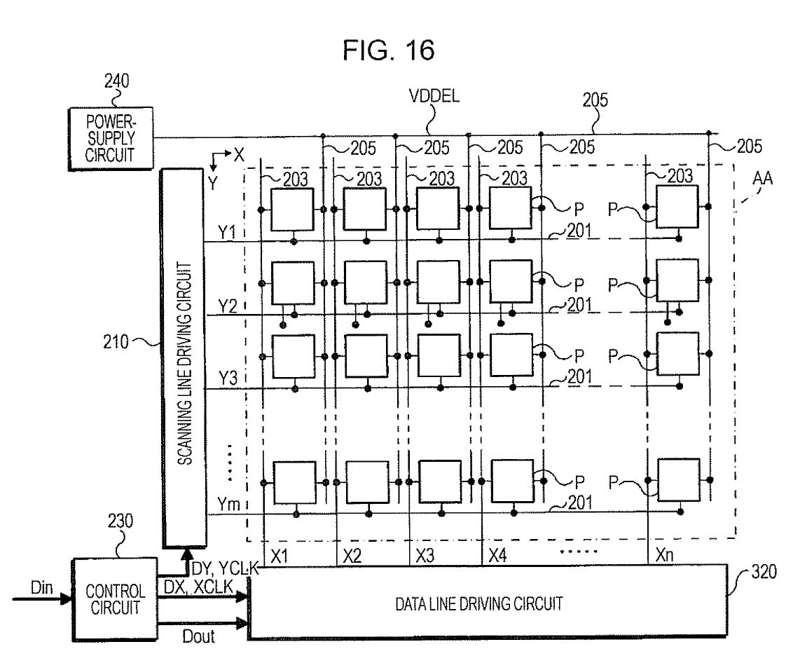

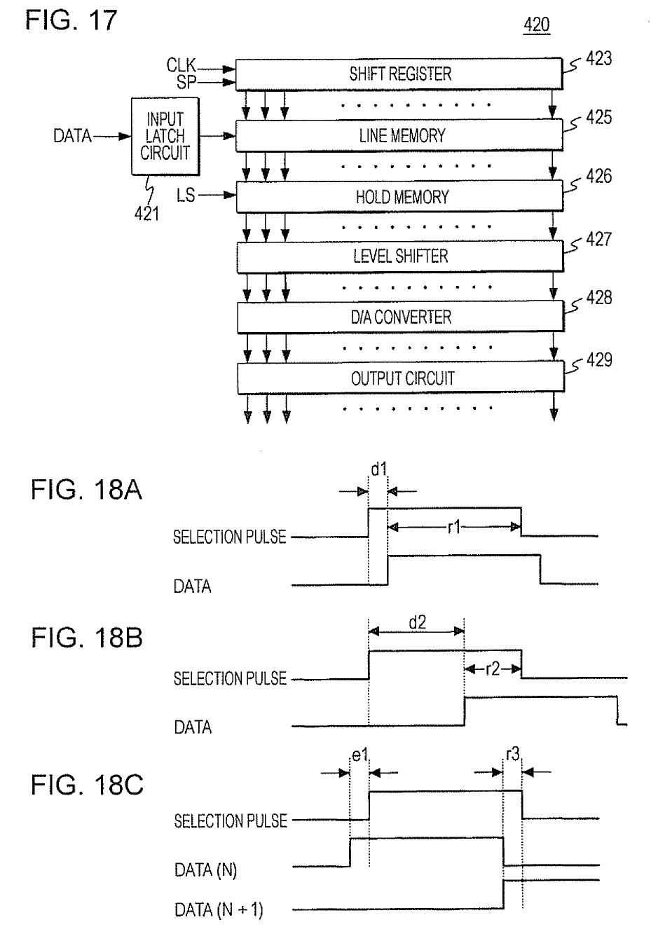

Furthermore, the data line driving circuit according to an embodiment of the invention can be applied to a liquid-crystal display device of an active-matrix-type or other display devices by being combined with a scanning line driving circuit. The configuration in this case will be described with reference to FIG. 16. FIG. 16 is a block diagram showing an example of the configuration of a display device. The display device includes a pixel area AA, a scanning line driving circuit 210, a data line driving circuit 320 to which the invention is applied, a control circuit 230, and a power-supply circuit 240.

In the pixel area AA, m scanning lines 201 are formed in parallel to an X direction. Furthermore, n data lines 203 are formed in parallel to a Y direction intersecting at right angles to the X direction. Pixel circuits P are provided so as to correspond to corresponding intersections of the scanning lines 201 and the data lines 203. A power-supply voltage VDDEL is supplied to each pixel circuit P via a power-supply line 205.

The scanning line driving circuit 210 generates scanning signals Y1, Y2, Y3, . . . , Ym for sequentially selecting a plurality of scanning lines 201. The scanning signals Y1 to Ym are generated by sequentially transferring a Y transfer start pulse DY in synchronization with a Y clock signal YCLK.

On the basis of output gray-scale data Dout, the data line driving circuit 320 supplies driving signals X1, X2, X3, . . . , Xn (driving signals VO1 to VO512 in each of the above-described embodiments) to the respective pixel circuits P positioned in the selected scanning line 201. In this example, the driving signals X1 to Xn are pulse signals that specify a gray-scale luminance on the basis of a pulse width.

The control circuit 230 generates various control signals, such as a Y clock signal YCLK, an X clock signal XCLK, an X transfer start pulse DY, and a Y transfer start pulse DY, and outputs these signals to the scanning line driving circuit 210 and the data line driving circuit 320. Furthermore, the control circuit 230 performs image processing, such as gamma correction, on input gray-scale data Din supplied from the outside, thereby generating output gray-scale data Dout.

Examples of electronic apparatuses using a display device include a cellular phone, a personal computer, a portable information terminal, a digital still camera, a television monitor, a viewfinder-type or direct-view-type video tape recorder, a car navigation apparatus, a pager, an electronic notebook, an electronic calculator, a word processor, a workstation, a video telephone, a POS terminal, or devices provided with a touch panel. Then, as display units of the various kinds of electronic apparatuses, the above-described display device can be applied.

The entire disclosure of Japanese Patent Application No: 2007-233691, filed Sep. 10, 2007 is expressly incorporated by reference herein.

What is claimed is:

1. A data line driving circuit comprising a plurality of blocks that are cascaded together,
wherein each of the plurality of blocks includes
a shift register that sequentially outputs a plurality of selection signals for each block in synchronization with a clock signal;
a data synchronization circuit that adjusts a phase of a data signal in which a plurality of items of data are arranged chronologically by using the clock signal as a reference and to output the data signal to a block of the next stage;
a data expansion circuit that expands the items of data of the data signal after being adjusted by the data synchronization circuit into a plurality of systems on the basis of the plurality of selection signals; and
a signal generation circuit that generates a driving signal corresponding to each item of data after being expanded by the data expansion circuit.

2. A data line driving circuit comprising a plurality of blocks that are cascaded together,
wherein each of the plurality of blocks includes
a shift register that sequentially outputs a plurality of selection signals for each block in synchronization with a clock signal;
a data synchronization circuit that adjusts a phase of a data signal in which a plurality of items of data are arranged chronologically by using as a reference an adjustment clock signal whose phase is delayed with respect to the clock signal and which has the same frequency as that of the clock signal and to output the data signal to a block of the next stage;
a data expansion circuit that expands the items of data of the data signal after being adjusted by the data synchronization circuit into data of a plurality of systems on the basis of the plurality of selection signals; and
a signal generation circuit that generates a driving signal corresponding to each item of data after being expanded by the data expansion circuit.

3. The data line driving circuit according to claim 1, wherein the data synchronization circuit delays the data signal so as to adjust the phase thereof, and
each of the plurality of blocks includes an adjustment circuit that delays a timing of the output of each selection signal from the shift register.

4. The data line driving circuit according to claim 3, wherein the adjustment circuit delays a start pulse on the basis of the clock signal, and
the shift register sequentially shifts the start pulse after being delayed by the adjustment circuit in synchronization with the clock signal, thereby generating the plurality of selection signals.

5. The data line driving circuit according to claim 2, wherein the data synchronization circuit includes a control unit that delays the data signal so as to adjust the phase thereof and that temporarily stops variations in a level of the clock signal so that a timing of an output of each of the selection signals by the shift register of each of the blocks is delayed.

6. The data line driving circuit according to claim 2,
wherein each of the plurality of blocks includes a first buffer unit, a second buffer unit, and a third buffer unit, the first buffer unit, the second buffer unit, and the third buffer unit having an equal driving performance, and
wherein, in each of the plurality of blocks,
the clock signal is input to the shift register via the first buffer unit,
the data signal is input to the data expansion circuit via the second buffer unit, and
the adjustment clock signal is input to the data expansion circuit of a block of the next stage via the third buffer unit.

7. An electro-optical apparatus comprising:
the data line driving circuit according to claim 1; and
a plurality of pixels that are driven on the basis of data signals output by the data line driving circuit.

8. An electronic apparatus comprising the electro-optical apparatus according to claim 7.
